(19) United States
(12) Patent Application Publication
(10) Pub. No.: US 2003/0087137 A1
(43) Pub. Date: May 8, 2003

(54) Techniques for making non-halogenated flame retardant cross-linked polyolefin material which is suitable for use in a cable

(76) Inventors: John P. Gagnon, Franklin, MA (US); Todd Pihl, Uxbridge, MA (US); Michael Quarrey, North Grafton, MA (US); Charlie Thebeau, Lunenburg, MA (US)

Correspondence Address: David E. Huang, Esq., CHAPIN & HUANG, L.L.C., Westborough Office Park, 1700 West Park Drive, Westborough, MA, 01581, US

(21) Appl. No.: 10/039,470

(22) Filed: Nov. 8, 2001

(51) Int. Cl. B32B 9/04

(52) U.S. Cl. 428/901

(57) ABSTRACT

A system makes a run of cross-linked non-halogenated flame retardant polyolefin material. The system includes an extruder having a die that defines an elongated opening which is at least 7.5 centimeters wide (e.g., substantially 40 centimeters wide). The extruder is configured to extrude molten non-halogenated flame retardant polyolefin material through the die. The system further includes a cooling assembly coupled to the extruder. The cooling assembly is configured to cool the extruded non-halogenated flame retardant polyolefin material so that the extruded non-halogenated flame retardant polyolefin material hardens into a sheet of non-halogenated flame retardant polyolefin material. The system further includes a cross-linking assembly which is configured to cross-link the sheet of non-halogenated flame retardant polyolefin material. Such material is well-suited for use in a variety of applications such as cables, construction materials and furniture, among other things.

### BACKGROUND OF THE INVENTION

Thermoplastic tape is commonly used in communication cables and power cables (hereinafter, generally referred to as cables). In particular, when a cable manufacturer makes a cable, the cable manufacturer often wraps thermoplastic tape around the cable conductors prior to extruding an outer insulator jacket around the cable conductors in order to protect the cable conductors against damage (e.g., against excessive heat during the jacketing process, from splitting if inadvertently hit during installation, from the negative affects of heat, smoke, flame, chemicals, abrasion and humidity after installation, etc.). Furthermore, some cable manufacturers use thermoplastic tape as a structural separator within cables in order to provide distance between cable conductors (e.g., to prevent the outer extruded jacket from shrinking and over-compressing the cable conductors as the jacket cools, to prevent particular cable conductors from getting too close together for signal integrity purposes, etc.).

The manufacturer of the above-described thermoplastic tape typically purchases the raw materials (e.g., pelletized thermoplastic material) for such tape from a raw materials supplier and then forms the thermoplastic tape from the raw materials. In one approach, the thermoplastic tape manufacturer extrudes molten thermoplastic material through a die and subsequently forms a run of thermoplastic tape. The thermoplastic tape manufacturer typically winds the run of thermoplastic tape into a roll for later use by the cable manufacturer.

It is common for the raw materials supplier to possess extrusion equipment in order to occasionally or periodically test manufacture the raw materials it supplies and sells. To this end, it is common for the raw materials supplier to take a raw material sample and extrude the sample through a small die which is typically no greater than two or three inches wide in order to confirm particular manufacturing characteristics of the sample (e.g., extrudability, consistency, specific gravity, tensile, elongation, etc.). For instance, the raw materials supplier can perform a “trial run” on particular raw materials ordered by the thermoplastic tape manufacturer in order to verify that the raw materials are suitable for use by the thermoplastic tape manufacturer.

The raw materials supplier can test samples of other types of raw materials such as raw materials for thermoset polymers. A thermoplastic polymer differs from a thermoset polymer in thermophysical behavior. In general, a thermoplastic polymer softens and flows upon heating, while a thermoset polymer does not soften or flow upon heating.

### SUMMARY OF THE INVENTION

Unfortunately, there are deficiencies to the above-described conventional cables which use thermoplastic tape. For example, the thermoplastic tape within these conventional cables tends to soften and melt if the cable conductors heat up. Such softening and melting can result in a loss of structural integrity in a cable (e.g., a thermoplastic tape which separates particular conductive cables from each other for signal integrity purposes can soften and lose its strength thus allowing the conductive cables to move closer to each other resulting in poorer signal integrity). Moreover, during a fire, the thermoplastic tape can easily liquefy and flow and thus provide little protection to conductors.

Embodiments of the invention are directed to techniques for making and using runs of cross-linked non-halogenated flame retardant polyolefin material. The cross-linked aspect of the material (i.e., the networked polymer configuration of molecules within the material) results in a thermoset product which has excellent thermostability and which is well-suited for use in a variety of applications such as cables (e.g., plenum cables), construction materials (e.g., vapor barriers and tarps), furniture (e.g., sofas and car seats) among other things. For example, the use of a run of cross-linked non-halogenated flame retardant polyolefin material as a tape within a cable, rather than the above-described conventional thermoplastic tape, provides more protection to conductors due to the thermoset properties of the run. In addition, the run can provide better electrical insulation, improved chemical resistance, and improved abrasion resistance.

One embodiment is directed to a run (e.g., a sheet, a tape, etc.) of cross-linked non-halogenated flame retardant polyolefin material made by a method which includes the steps of extruding molten non-halogenated flame retardant polyolefin material through a die that defines an elongated opening which is at least 7.5 centimeters wide, and cooling the extruded non-halogenated flame retardant polyolefin material so that the extruded non-halogenated flame retardant polyolefin material hardens into a sheet of non-halogenated flame retardant polyolefin material. The method further includes the step of cross-linking the sheet of non-halogenated flame retardant polyolefin material. The use of the die that defines an elongated opening which is at least 7.5 centimeters wide permits the manufacture of a wide sheet of essentially unlimited length. Such a sheet can be wound onto a large core for subsequent use in a secondary process. Alternatively, such a sheet can be cut lengthwise into multiple feeds which are either consumed immediately (e.g., included in the manufacture of cable in a contiguous manner) or wound in extremely long lengths onto cores for later use. The manufacture of such a wide sheet results in the capability of manufacturing many feeds simultaneously thus lowering manufacturing costs and making efficient use of resources (e.g., extruding equipment, manpower, etc.).

In one arrangement, cross-linking involves applying an electron-beam to the sheet of non-halogenated flame retardant polyolefin material. The use of the electron-beam provides a safe and controllable mechanism for cross-linking non-halogenated flame retardant polyolefin material that has incorporated a photo initiator as a catalyst.

In one arrangement, cooling the extruded non-halogenated flame retardant polyolefin material so that the extruded non-halogenated flame retardant polyolefin material hardens into a sheet of non-halogenated flame retardant polyolefin material involves forming, as the sheet of non-halogenated flame retardant polyolefin material, a web having a width which is substantially 40 centimeters wide (e.g., roughly half a meter wide) for increased economies of scale (e.g., a sheet that can be cut into 20 to 60 concurrent feeds).

Other embodiments of the invention are directed to a cable having a set of conductors, at least one run of cross-linked non-halogenated flame retardant polyolefin material, and a jacket extruded around the set of conductors and each run of cross-linked non-halogenated flame retardant polyolefin material. Such use of the run of cross-linked non-halogenated flame retardant polyolefin material results in a more thermally stable cable than the earlier-described conventional cable that uses thermoplastic tape.

In one arrangement, each run of cross-linked non-halogenated flame retardant polyolefin material (i) includes a crease along a midline of that run and (ii) is positioned to separate conductors of the set of conductors. In this arrangement, the run operates as a separator tape for separating the conductors in order to avoid over-compression and for signal integrity purposes.

In one arrangement, a run of cross-linked non-halogenated flame retardant polyolefin material wraps around the set of conductors. In this arrangement, the run is well-suited for operating as a cable wrap which protects the conductors against damage (e.g., against heat during the jacketing process, against physical damage during installation, and against exposure to heat, chemicals, and moisture after installation, etc.).

The features of the invention, as described above, may be employed in manufacturing systems and methods for making cross-linked non-halogenated flame retardant polyolefin material, as well as various products which use such material, such as those of Film X, Inc. of Dayville, Conn.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a system for making a run of cross-linked non-halogenated flame retardant polyolefin material which is suitable for use by the invention.

FIG. 2 is a perspective view of an extruding die which is suitable for use within the system of FIG. 1.

FIG. 3 is a block diagram of a tape manufacturing system which includes the system of FIG. 1.

FIG. 4 is a perspective view of various materials used and/or produced by the tape manufacturing system of FIG. 3.

FIG. 5 is a block diagram illustrating a cross-linking operation performed by the system of FIG. 1.

FIG. 6 is a flowchart of a procedure which is performed by the systems of FIGS. 1 and 3.

FIG. 7 is a block diagram of an alternative tape manufacturing system which includes the system of FIG. 1.

FIG. 8 is a block diagram of a cable manufacturing system which utilizes a run of cross-linked non-halogenated flame retardant polyolefin material.

FIG. 9 is a flowchart of a procedure which is performed by the cable manufacturing system of FIG. 8.

FIG. 10 is a cross-sectional view of a first configuration cable for a cable which can be manufactured by the cable manufacturing system of FIG. 8.

FIG. 11 is a cross-sectional view of a second configuration cable for a cable which can be manufactured by the cable manufacturing system of FIG. 8.

FIG. 12 is a perspective view of a third configuration cable for a cable which can be manufactured by the cable manufacturing system of FIG. 8.

### DETAILED DESCRIPTION

Embodiments of the invention are directed to techniques for making and using runs of cross-linked non-halogenated flame retardant polyolefin material, e.g., sheets, multiple feeds, etc. The term sheet generally refers to a thermoplastic sheet, web, or film having a thickness between 0.002 cm and 1.270 cm (i.e., roughly 0.001 and 0.500 inches). The cross-linked aspect of the material (i.e., the networked polymer configuration of molecules within the material) results in a thermoset product which has exceptional temperature stability, chemical and abrasion resistance, and electrical insulation properties and which is well-suited for use in a variety of applications such as cables (e.g., plenum cables), construction materials (e.g., vapor barriers and tarps), furniture (e.g., sofas and car seats) among other things.

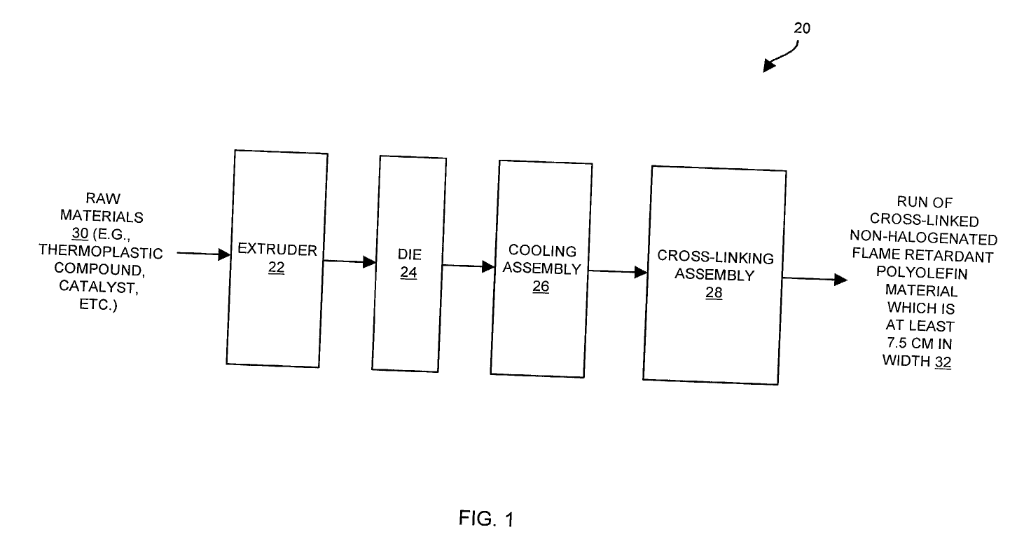

FIG. 1 shows a general manufacturing system 20 for making a run of cross-linked non-halogenated flame retardant polyolefin material which is suitable for use by the invention. The manufacturing system 20 includes an extruder 22, an extruding die 24, a cooling assembly 26 and a cross-linking assembly 28 which are configured to operate in a pipelined manner.

During operation, the extruder 22 receives non-halogenated flame retardant polyolefin compound as raw material 30. In one arrangement, the compound initially has the form of a pelletized thermoplastic resin (e.g., polypropylene filled with magnesium hydroxide with an appropriate photo initiator). The extruder 22 then (i) grinds and heats the raw material 30 into a molten form, i.e., molten non-halogenated flame retardant polyolefin material, and (ii) pushes the molten thermoplastic material through the extruding die 24 to form a contiguous molten sheet of non-halogenated flame retardant polyolefin material.

Next, the cooling assembly 26 cools the molten sheet into a contiguous solid run of non-halogenated flame retardant polyolefin material. At this point, the solid run of non-halogenated flame retardant polyolefin material exhibits thermoplastic properties. In one arrangement, the cooling assembly 26 includes a tank that holds the liquid cooling bath which receives the molten sheet. When the molten sheet travels through the cooling bath, the molten sheet solidifies as its temperature drops. As the solid sheet exits the liquid cooling bath of the cooling assembly 26, vacuum rollers of the cooling assembly 26 remove excess bath liquid from the solid sheet. In an alternative arrangement, the cooling assembly 26 includes a set of chilled rollers (i.e., one or more chilled rollers) in place of the liquid cooling bath. In this alternative arrangement, the molten sheet is extruded onto and/or through the set of chilled rollers which cools and solidifies the molten sheet.

Subsequently, the cross-linking assembly 28 cross-links the contiguous solid run to provide a run of cross-linked non-halogenated polyolefin material. The run can include both cross-linkable material and non-cross-linkable material. The cross-linking assembly 28 cross-links the cross-linkable material within the run.

After such cross-linking (e.g., electron-beaming, ultraviolet radiation curing, moisture curing, chemical curing, etc.), the solid run of non-halogenated flame retardant polyolefin material no longer exhibits thermoplastic properties. Rather, the material is now a thermoset. Accordingly, the material has higher temperature stability than the earlier-described conventional thermoplastic tape, and is well-suited for a variety of temperature sensitive uses such as operating as a separator tape or a cable wrap in communications and power cable. For example, the cross-linked non-halogenated flame retardant polyolefin material will not soften and reflow like thermoplastic tape and thus continue to provide strong signal integrity. The thermoset material also exhibits improved resistance to chemicals and abrasion and has improved electrical insulation properties.

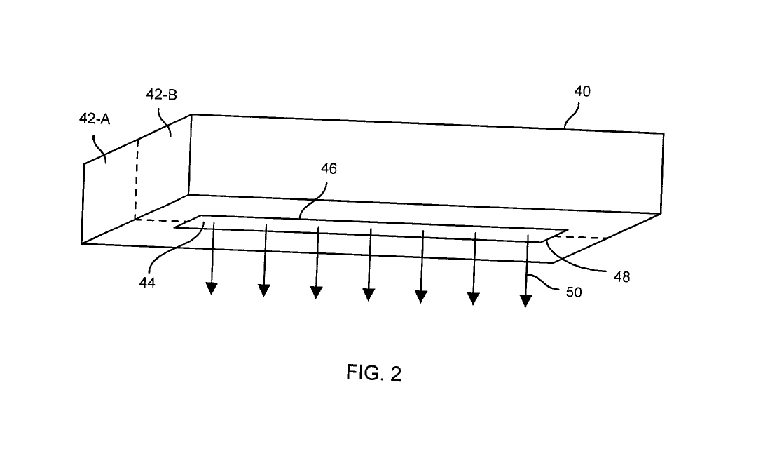

FIG. 2 shows a perspective view of a die 40 which is suitable for use as the extruding die 24. The die 40 includes multiple members 42 (i.e., a first side member 42-A and a second side member 42-B.) which fasten together to define an elongated opening 44 having a width 46 and a depth 48, with the width 46 being substantially greater than the depth 48 in order to form the molten sheet of non-halogenated flame retardant polyolefin material. The width 46 is at least 7.5 centimeters long (e.g., 40 centimeters long) in order to provide a sheet. Such a sheet can be wound and stored for use in a secondary process, or alternatively immediately cut and wound in order to form multiple contiguous feeds of non-halogenated flame retardant polyolefin material (e.g., 50 to 60 feeds) thus providing an economical means of manufacturing many essentially endless feeds of non-halogenated flame retardant polyolefin material (e.g., tape which can be wound onto cores for later use in cables) at the same time.

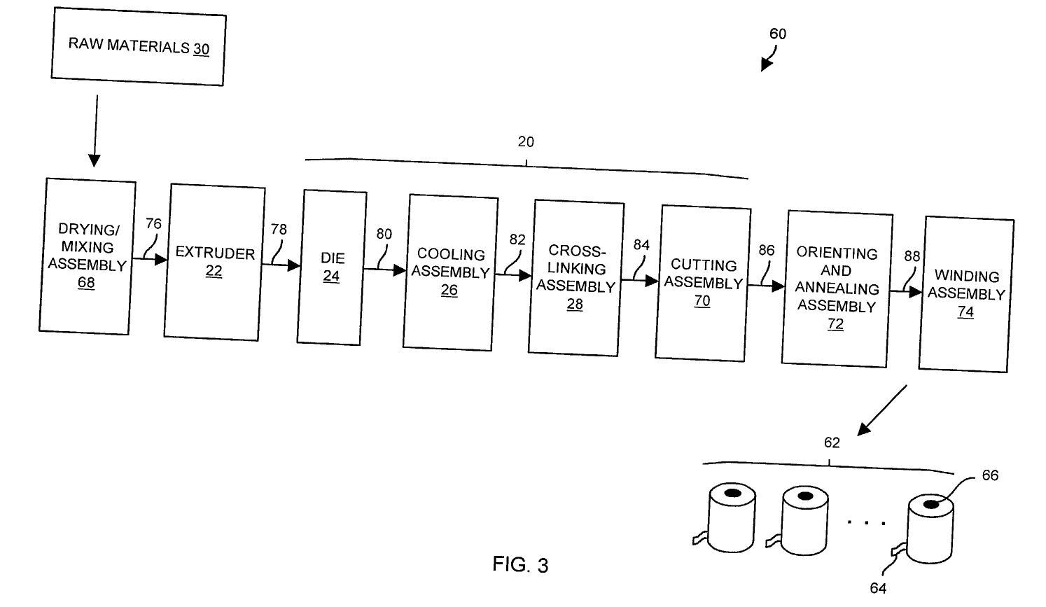

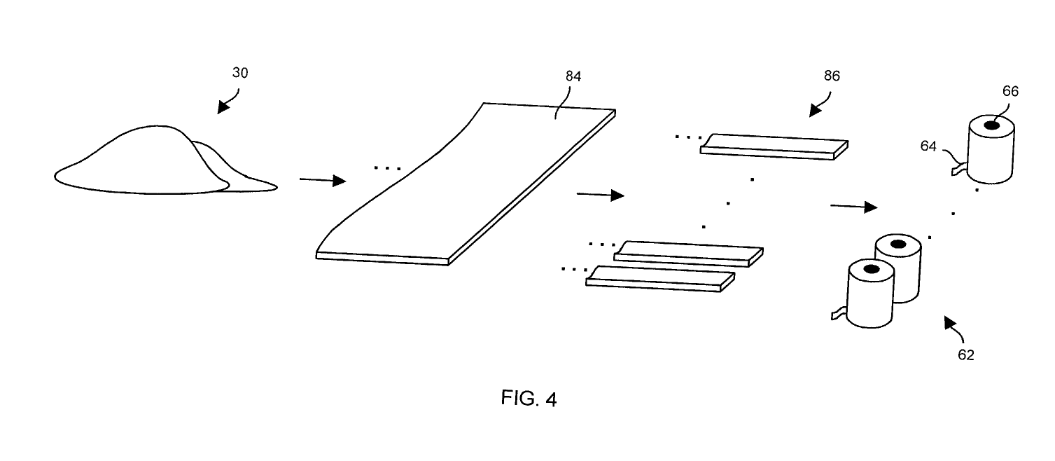

In one arrangement, the die 40 is located such that the elongated opening 44 points in a downward direction 50 such that the molten sheet of non-halogenated flame retardant polyolefin material drops (e.g., due to gravity) into a liquid cooling bath of the cooling assembly 26 (FIG. 1). Further details of the invention will now be provided with reference to FIGS. 3 and 4.

FIG. 3 shows the components 22, 24, 26, 28 of the manufacturing system 20 integrated within a tape manufacturing system 60 which makes, as runs of non-halogenated flame retardant polyolefin material, rolls 62 of non-halogenated flame retardant polyolefin tape. As will be explained later, such tape can be used in cable, for example as separator tape or as a cable wrap. Each roll 62 includes an individual feed 64 of non-halogenated flame retardant polyolefin material cut from a wider sheet of at least 7.5 cm and a core 66 (e.g., a cardboard tube).

The tape manufacturing system 60 includes a drying/mixing assembly 68, the above-described extruder 22, the extruding die 24, the cooling assembly 26, the cross-linking assembly 28, a cutting assembly 70, an orientating and annealing assembly 72, and a winding assembly 74.

FIG. 4 shows various materials which are used and/or provided by the tape manufacturing system 20. As shown in both FIGS. 3 and 4, the tape manufacturing system 60 initially receives raw material 30. The raw material 30 includes non-halogenated flame retardant polyolefin compound. This compound includes at least some cross-linkable material which is cross-linked by the cross-linking assembly 28. The raw material 30 can further include additives such as a colorant, cross-linking catalysts, fillers, etc. The colorant adds color to the run. The cross-linking catalysts facilitate conversion of the run from a thermoplastic material to a thermoset material. The fillers enhance the properties of the material (e.g., improve flame resistance, increase brittleness or flexibility, etc.) thus enabling customization of the material for a variety of applications.

The drying/mixing assembly 68 dries and mixes the raw material 30 (i.e., the non-halogenated flame retardant polyolefin compound along with any additives), and provides the raw material 30 to the components 22, 24, 26, 28 of the manufacturing system 20 (also see FIG. 1). Then, as described earlier, the extruder 22 extrudes the material in molten form 78 through the extruding die 24 having a width which is at least 7.5 cm in order to form a contiguous molten sheet 80. The cooling assembly 26 cools the contiguous molten sheet 80 into a contiguous solid sheet 82 having thermoplastic properties. Then, the cross-linking assembly 28 cross-links the contiguous solid sheet 82 into a contiguous run of thermoset material, i.e., a run of cross-linked non-halogenated flame retardant polyolefin material 84 (see FIGS. 3 and 4) having a width which is at least 7.5 cm.

Next, the cutting assembly 36 cuts the solid sheet 84 into multiple parallel feeds 86 (FIG. 4). In one arrangement, the cutting assembly 70 includes a row of blades mounted in fixed positions so that the resulting feeds 86 have defined (e.g., uniform) widths. An example range of widths for each feed 86 is roughly between 0.3 cm to 5.1 cm (0.125 to 2.000 inches). In another arrangement, the cutting assembly 70 includes a row of sheer blades which cut the solid sheet 84 into the multiple parallel feeds 86.

The orientating and annealing assembly 72 then brings the multiple parallel feeds 86 into a finished state. In one arrangement, the orientating and annealing assembly 72 stretches and anneals the multiple parallel feeds 86 to orient molecules within the feeds 86 such that the tensile strength of each feed 86 is greater in the lengthwise direction along the feed 86 than in the widthwise direction across the feed 86, the widthwise direction being substantially perpendicular to the lengthwise direction. In another arrangement, the orientating and annealing assembly 72 simply reheats and cools the feeds 86 to repair and/or strengthen the molecular bonds within the feeds 86 in all directions.

Next, the winding assembly 74 (see FIG. 1) concurrently winds the multiple feeds 86 exiting the orientating assembly 72 onto the cores 66 to form the multiple rolls 62 of cross-linked non-halogenated flame retardant polyolefin tape 62. In particular, the feeds 86 extend in a side-by-side manner from the orientating assembly 72 for handling by the winding assembly 74. In one arrangement, each feed 86 passes through a series of eyelets which guides that feed 86 onto a respective winder of the winding assembly 74 and a respective core 66. In one arrangement, the feeds 86 roll onto cores 66 which are substantially wider than the feeds 86 so that the feeds 86 can traverse wind onto the cores 66 in a side-by-side manner to form, as the multiple rolls 62, spools of cross-linked non-halogenated flame retardant polyolefin tape 64, i.e., like spools of thread (see FIGS. 3 and 4). In another arrangement, the feeds 86 wind onto the cores 66 in a continuous overlapping manner to form, as the multiple rolls 62, a set of pads or “pancakes” of cross-linked non-halogenated flame retardant polyolefin tape 64, i.e., like roles of masking tape.

It should be understood that the use of the winding assembly 74 in the tape manufacturing system 60 enables multiple rolls 62 of cross-linked non-halogenated flame retardant polyolefin tape to be created in a contiguous manner. Accordingly, the use of the winding assembly 74 in the system 60 is well-suited for making spools 62 having extremely long lengths with no weak points (e.g., with no splice points). For example, each roll 62 of tape (see FIG. 3) can easily exceed 2,500 feet in length (e.g., 50,000 foot lengths, 100,000 foot lengths, etc.).

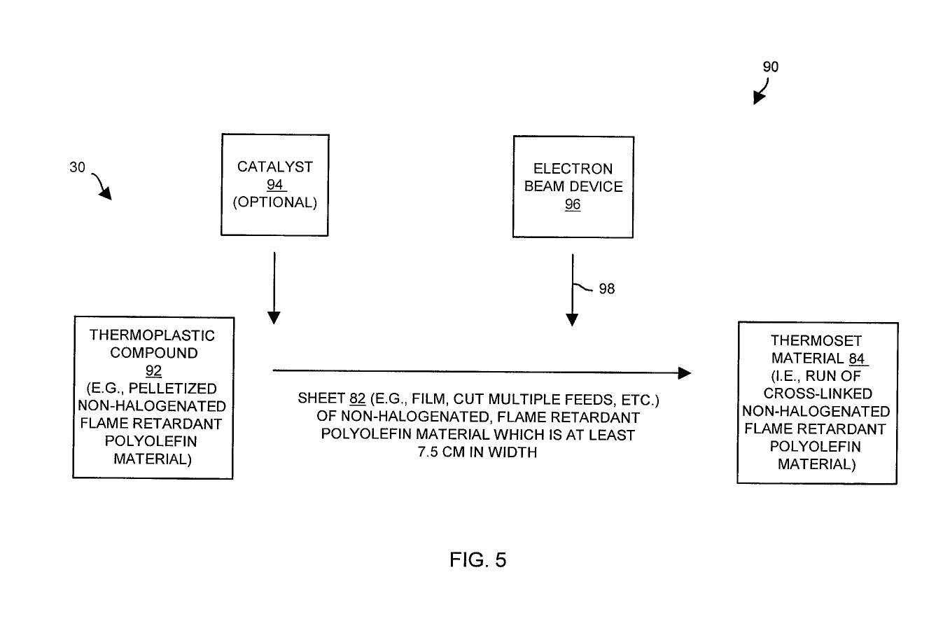

A similar tape manufacturing system which can incorporate a cross-linking assembly to provide cross-linked non-halogenated flame retardant polyolefin tape is described in U.S. patent application Ser. No. 09/853,972, entitled “TECHNIQUES FOR MAKING NON-HALOGENATED FLAME RETARDANT POLYOLEFIN TAPE FOR USE IN A CABLE,” which is assigned to Film X, Inc. of Dayville, Conn., the teachings of which are hereby incorporated by reference in their entirety. Further details of the invention will now be provided with reference to FIG. 5.

FIG. 5 shows a block diagram illustrating a cross-linking configuration 90 which is suitable for use by the systems 20, 60 (see FIGS. 1 and 3). As shown in FIG. 5, the raw materials 30 include thermoplastic compound 92 and a cross-linking catalyst 94 (e.g., a catalyst that facilitates electron beam radiation curing). The systems 20, 60 turns the raw materials 30 into a sheet 82 of non-halogenated flame retardant polyolefin material which is at least 7.5 cm in width (also see FIG. 3). The sheet 82 has thermoplastic properties (e.g., can melt and reflow). An electron beam device 96 of the cross-linking assembly 28 then applies an electron beam 98 to the sheet 84 thus activating the photo initiator and converting the sheet 82 into thermoset material, i.e., a run of cross-linked non-halogenated flame retardant polyolefin material.

It should be understood that the use of the electron-beam device 96 employs a safe and controllable mechanism for cross-linking the non-halogenated flame retardant polyolefin material. Nevertheless, other cross-linking mechanisms are suitable for use as well such as chemical curing, oil bath curing, etc. Such cross-linking converts the non-halogenated flame retardant polyolefin material into a thermoset thus providing material which is more thermally stable (e.g., does not reflow or soften in response to heat) than the earlier-described conventional thermoplastic tape used in conventional cables. Accordingly, the run of cross-linked non-halogenated flame retardant polyolefin material provided by the systems 20, 60 (see FIGS. 1 and 3) makes superior separator tape and cable wrap for cables.

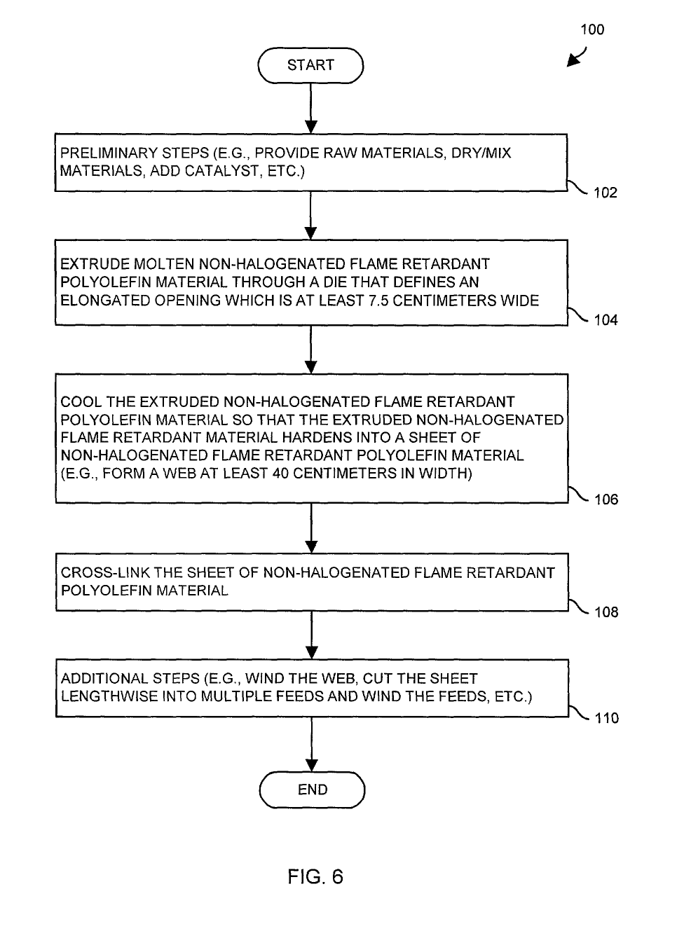

FIG. 6 shows a procedure 100 which is performed by the system 60 of FIG. 3 (as well as the system 20 of FIG. 1). In step 102, the system 60 performs preliminary steps such as providing and conditioning (e.g., drying and mixing) the raw materials 30 for input into the extruder 22 (see FIGS. 1 and 3). During step 102, additives such as a cross-linking catalyst, colorant, etc. can be added.

In step 104, the extruder 22 of the system 60 extrudes molten non-halogenated flame retardant polyolefin material through an extruding die 24 that defines an elongated opening which is at least 7.5 cm wide (e.g., also see the die 50 in FIG. 2). As a result, a molten sheet 80 of non-halogenated flame retardant polyolefin material exits the extruding die 24.

In step 106, the cooling assembly 26 cools the molten sheet 80 thus forming a solid sheet 82 of non-halogenated flame retardant polyolefin material. At this point, the sheet 82 is still a thermoplastic material.

In step 108, the cross-linking assembly 28 cross-links the sheet 82 to form a sheet 84 having thermoset properties. In one arrangement, such cross-linking involves applying an electron beam to the sheet 82 using an electron beam device.

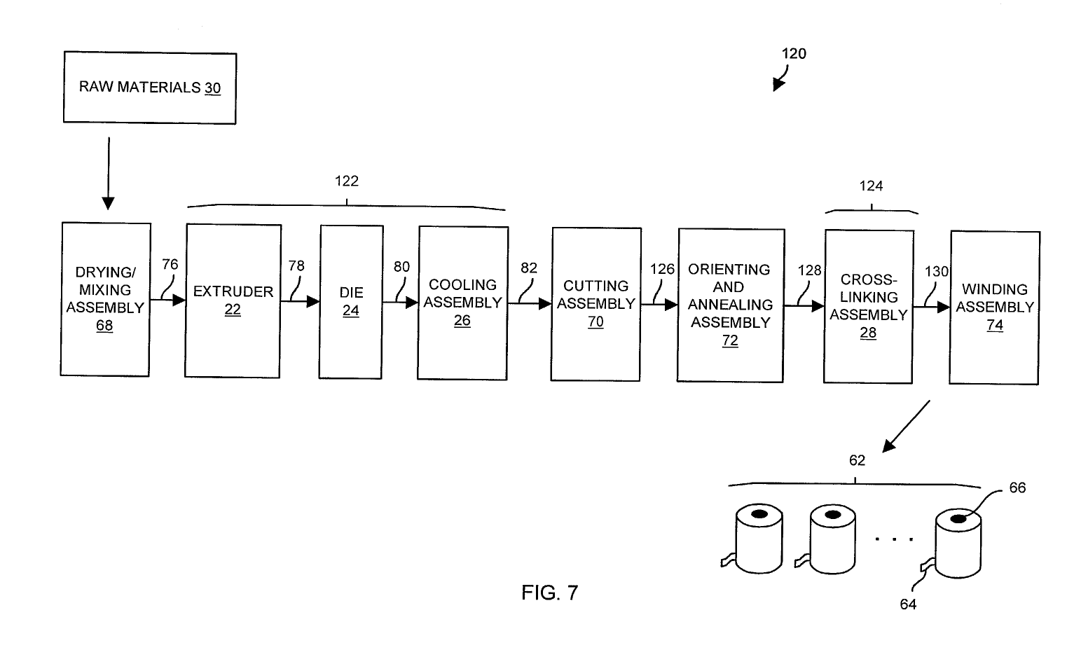

In step 110, the system 60 performs additional steps such as winding the sheet 84 onto a large core (e.g., a core that is 40 cm wide) for use in a secondary process, cutting the sheet 84 into multiple feeds 86 and concurrently winding the feeds 86 into rolls 62 of tape 64. It should be understood that the minimum width for the sheet 84 is 7.5 cm and that wider sheets permit the manufacture of more feeds (e.g., 20 to 60 feeds) thus lowering manufacturing costs and making efficient use of resources (e.g., equipment in the system 60, manpower that operates the equipment, etc.). Further details of the invention will now be provided with reference to FIG. 7.

FIG. 7 shows a tape manufacturing system 120 which is an alternative to the system 60 of FIG. 3. The tape manufacturing system 120 is similar to the system 60 except that the components 22, 24, 26, 28 are separated into multiple parts 122, 124. In particular, the extruder 22, the extruding die 24 and the cooling assembly 26 (i.e., the part 122) reside in similar positions in both systems 60, 120. However, in contrast to the system 60 of FIG. 3, the next stage after the cooling assembly 26 in the system 120 is the cutting assembly 70. The cross-linking assembly 28 resides between the orientating and annealing assembly 72 and the winding assembly 74. Accordingly, the cutting assembly 70 and the orientating and annealing assembly 72 process the material while it is still a thermoplastic. In particular, the cutting assembly 70 cuts the contiguous solid sheet 82 which is at least 7.5 cm wide into multiple contiguous feeds 126, and the orientating and annealing assembly repairs and/or strengthens the feeds 126 thus providing contiguous feeds 128 of non-halogenated flame retardant polyolefin having thermoplastic properties.

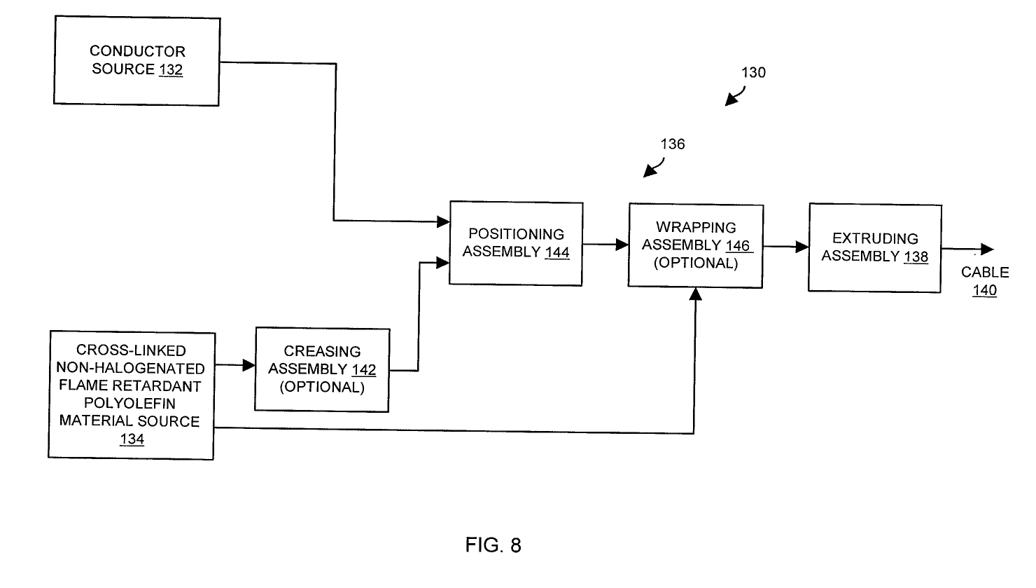

The cross-linking assembly 28 then cross-links the feeds 128 thus changing the material into a thermoset (e.g., applying one or more electron beams to the feeds 128). Accordingly, the cross-linking assembly 28 concurrently provides multiple runs 130 of cross-linked non-halogenated flame retardant polyolefin material to the winding assembly 74 which simultaneously winds the runs into rolls 62 of cross-linked non-halogenated flame retardant polyolefin tape. Such tape is well-suited for use in cables (e.g., as a separator tape, as a cable wrap, etc.). Further details of the invention will now be provided with reference to FIG. 8.

FIG. 8 is a block diagram of a cable manufacturing system 130 which is suitable for use by the invention. The cable manufacturing system 130 includes a conductor source 132, a cross-linked non-halogenated flame retardant polyolefin material source 134, a handling subsystem or assembly 136, and an extruding assembly 138. The components 132, 134, 136, 138 operate to form a cable 140 having a set of conductors, at least one run of cross-linked non-halogenated flame retardant polyolefin material, and a jacket extruded around the set of conductors and each run of cross-linked non-halogenated flame retardant polyolefin material.

During operation, the conductor source 132 provides a set of conductors (e.g., one or more pairs of insulated wires). Concurrently, the cross-linked non-halogenated flame retardant polyolefin material source 134 provides at least one run of cross-linked non-halogenated flame retardant polyolefin tape. The earlier-described tape manufacturing systems 60, 120 (see FIGS. 3 and 7) are suitable for use as the cross-linked non-halogenated flame retardant polyolefin material source 134. The handling subsystem 136 maneuvers the set of conductors and the tape, and the extruding assembly 138 applies a jacket around the set of conductors and the tape to form the cable 140.

By way of example only, the handling subsystem 136 can include a creasing assembly 142, a positioning assembly 144 and a wrapping assembly 146. The creasing assembly 142 is useful when using one or more run of the cross-linked non-halogenated flame retardant polyolefin material as separator tape which physically separates particular conductors from each other within the cable 140. The positioning assembly 144 is useful for positioning one or more separator tapes between conductors prior to jacket extrusion. Separator tapes provide space between cable conductors in order to avoid damage from over-compression when the cable jacket is installed around the conductors, and in order to improve signal integrity characteristics of the cable (e.g., to provide distance between conductors in order to reduce noise/cross-talk between conductors).

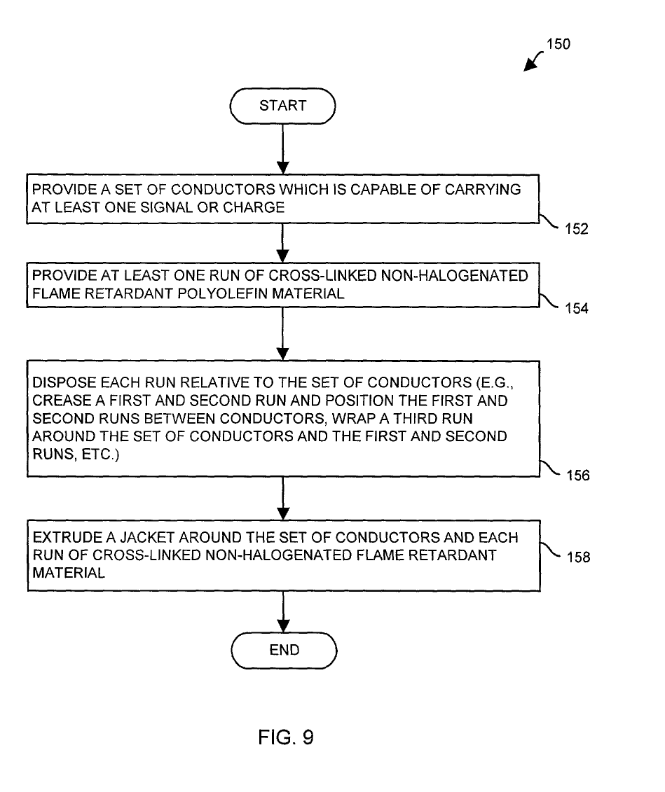

The wrapping assembly 146 is useful for wrapping the set of conductors with cross-linked non-halogenated flame retardant polyolefin tape prior to jacket extrusion. Such wrapping protects the cable conductors against damage through the lifetime of the cable. In particular, the cable wrap protects the cable conductors against, among other things, (i) heat during the jacketing process, (ii) physical damage during installation, and (iii) exposure to heat and moisture after installation. Further details of the invention will now be provided with reference to FIG. 9.

FIG. 9 shows a procedure 150 which is performed by the cable manufacturing system 130. In step 152, the conductor source 132 provides a set of conductors which is capable of carrying at least one signal or charge (e.g., a communications signal, a power signal, etc.).

In step 154, the cross-linked non-halogenated flame retardant polyolefin material source 134 provides at least one run of cross-linked non-halogenated flame retardant polyolefin tape (also see the rolls 62 of FIGS. 3 and 7).

In step 156, the handling subsystem 136 disposes each run of cross-linked non-halogenated flame retardant polyolefin tape relative to the set of conductors. For example, the creasing assembly 142 can crease a first run and a second run of the tape for use as separator tapes, the positioning assembly 144 can position the first and second runs between conductors, and/or the wrapping assembly 146 can wrap the set of conductors with a third run of the tape.

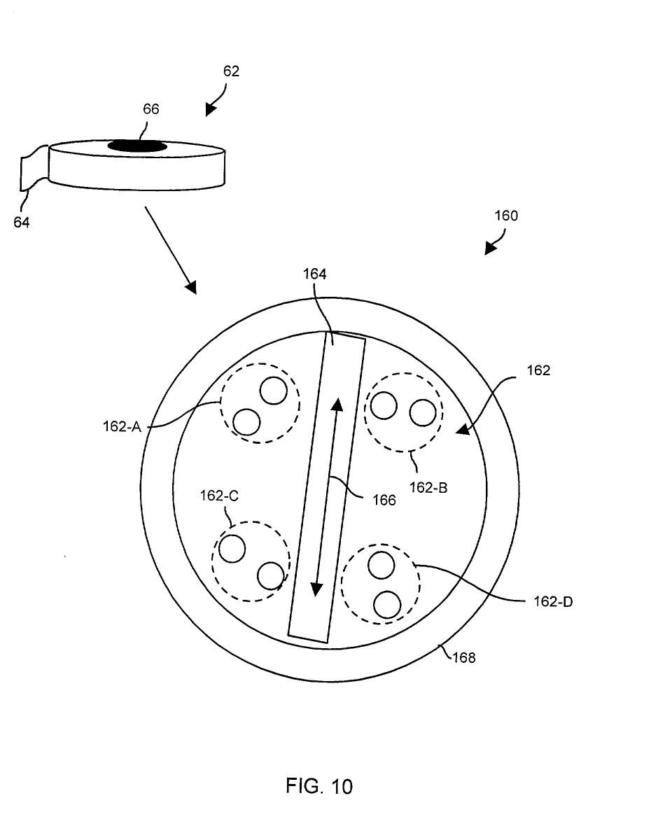

In step 158, the extruding assembly 138 extrudes a cable jacket around the set of conductors and each run of cross-linked non-halogenated flame retardant polyolefin tape in order to form the cable 140. The cable 140 is more thermally stable and, among other things, has (i) improved chemical and abrasion resistance and (ii) improved electrical insulation properties than the earlier-described conventional cables which use thermoplastic tape. The cross-linked non-halogenated flame retardant polyolefin tape of the cable 140 will not soften under heat and thus maintain the signal integrity characteristics of the cable 140, and will not become molten and liquefy (e.g., in a manner that could injure firefighters). Further details of the invention will now be provided with reference to FIGS. 10 through 12.

FIG. 10 is a cross-sectional view of a first cable 160 which can be manufactured by the cable manufacturing system 130. As shown, the first cable configuration 160 for the cable 140 which utilizes a roll 62 of tape provided by the cross-linked non-halogenated flame retardant polyolefin material source 134 (e.g., the systems 20, 60, 120). The roll 62 has a feed 64 of cross-linked non-halogenated flame retardant polyolefin tape around a core 66.

By way of example only, the cable configuration 160 of FIG. 10 includes multiple pairs of wires 162-A, 162-B, 162-C, 162-D (e.g., twisted pairs 162) as the set of conductors. The positioning assembly 144 (FIG. 8) incorporates the feed 64 from the roll 62 of tape (step 156 of FIG. 9) as a separator tape 164 within the cable configuration 160 to provide separation between the pairs 162-A, 162-C and the pairs 162-B, 162-D for signal integrity purposes, as well as structural support in the directions 166. Accordingly, when the extruding assembly 138 (FIG. 8) extrudes a jacket 168 around the pairs 162 and the separator tape 164, the separator tape resists over-compression of the pairs 162. Furthermore, the separator tape 164 provides distance between the pairs 162 for signal integrity purposes.

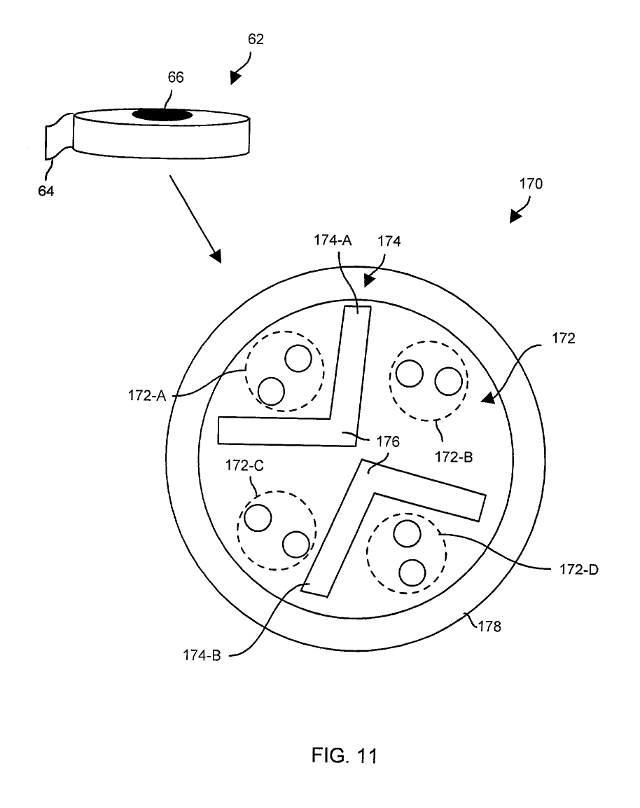

FIG. 11 is a cross-sectional view of a second cable configuration 170 for the cable 140 which also can be manufactured by the cable manufacturing system 130. As shown, the second cable configuration 170 also utilizes a roll 62 of tape provided by the cross-linked non-halogenated flame retardant polyolefin material source 134. As will now be explained and by way of example only, the second cable configuration 170 uses multiple feeds 64 of tape, i.e., two rolls at a time in order to obtain a first feed and a second feed of the tape.

As shown in FIG. 11, the second cable configuration 170 of FIG. 11 includes multiple pairs of wires 172-A, 172-B, 172-C, 172-D (collectively, wire pairs 172) as the set of conductors. The handling subsystem 136 (FIG. 8) incorporates the multiple feeds 64 of tape as separators 174-A, 174-B (collectively, separators 174) which separate the pairs of wires 172. In particular, the creasing assembly 142 places creases 176 in the separators 174 and the positioning assembly 144 positions the separators 174 between the wire pairs 172. Subsequently, the extruding assembly 138 extrudes a jacket 178 around the wire pairs 172 and the separators 174 to form the cable configuration 170. The separators 174 provide separation between the wire pairs 172 for signal integrity purposes (e.g., to reduce cross-talk between wire pairs 172).

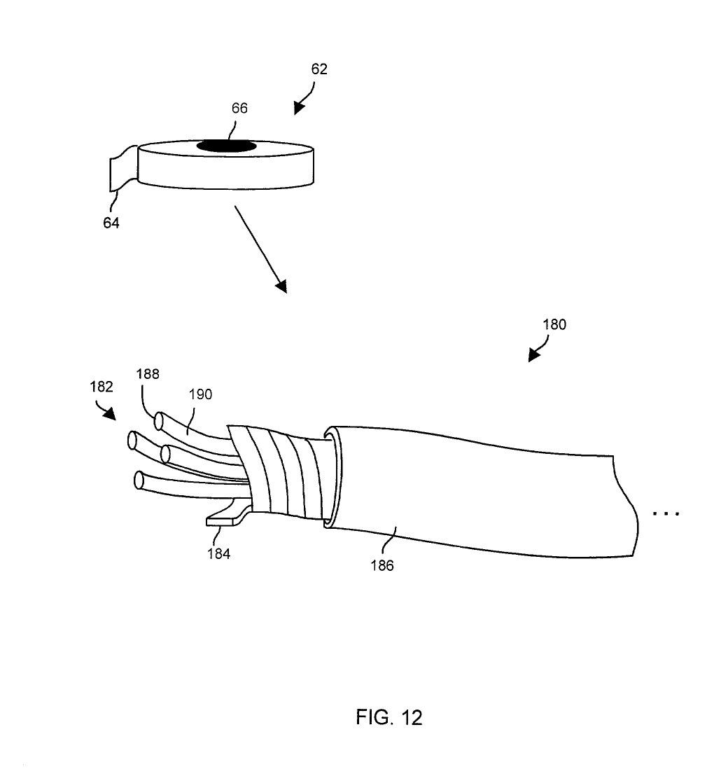

FIG. 12 is a perspective view of a third cable configuration 180 for the cable 140 which can be manufactured by the cable manufacturing system 130. The third cable configuration 180 utilizes a roll 62 of tape provided by the cross-linked non-halogenated flame retardant polyolefin material source 134. In particular, the wrapping assembly 146 (FIG. 8) wraps a set of conductors 182 provided by the conductor source 132 using the feed 64 of the roll 62 as a cable wrap 184. The extruding assembly 138 (FIG. 8) then extrudes a jacket 186 around the set of conductors 182 and the cable wrap 184 to form the cable configuration 180.

The cable wrap 184 protects the set of conductors 182 against damage during the extruding process, as well as during and after cable installation. For example, each conductor 182 can have a metallic conductive portion (e.g., solid or stranded copper) and an insulation portion, and the cable wrap 184 prevents the insulation portion from melting during extrusion. As another example, the cable wrap 184 prevents the conductors from being crushed during installation, and resists damage from heat, chemicals, abrasion, and/or moisture after installation (e.g., if the conductors heat up, during a fire, etc.).

As described above, embodiments of the invention are directed to techniques for making and using runs of cross-linked non-halogenated flame retardant polyolefin material, e.g., sheets, multiple feeds, etc. The cross-linked features of the material results in a thermoset product which has exceptional thermostability, chemical and abrasion resistance, and electrical insulation properties and which is well-suited for use in a variety of applications (e.g., communications and power cables). The features of the invention, as described above, may be employed in tape manufacturing systems, devices, products and methods for making runs of cross-linked non-halogenated flame retardant polyolefin material, as well as various systems, products and methods which use such material, such as those of Film X, Inc. of Dayville, Conn.

While this invention has been particularly shown and described with references to preferred embodiments thereof, it will be understood by those skilled in the art that various changes in form and details may be made therein without departing from the spirit and scope of the invention as defined by the appended claims.

For example, it should be understood that the cross-linking assembly 28 was described above by way of example only as cross-linking using a radiation curing mechanism, namely an electron beam device 96 that applies an electron beam 98 to the material. In other arrangements, the cross-linking process cross-links the material using a different process such as ultraviolet light curing, moisture curing, chemical curing (e.g., using a catalyst), thermal curing (e.g., using a hot oil bath), combinations thereof and the like.

Additionally, it should be understood that the dimensional width of the sheets of cross-linked non-halogenated flame retardant polyolefin material was provided as 40 cm by way of example only. In other arrangements, other widths which are wider than 7.5 cm are suitable as well such as other widths in the range between 7.5 cm and 2.0 meters. The larger width sheets enable more feeds of tape to be produced in a secondary process thus lowering manufacturing costs when making the tape.

Furthermore, it should be understood that the configurations 160, 170, 180 (see FIGS. 10 through 12) for the cable 140 were provided by way of example only. In other arrangements, the cable 140 has other configurations such as one that includes both a separator tape and a cable wrap.

Additionally, it should be understood that the configuration of components of the tape manufacturing systems 60, 120 were provided by way of example only. Other configurations are suitable for use as well. For example, it should understood that particular components such as the drying/mixing assembly 68 (FIG. 3) is optional, and that the tape manufacturer can obtain pre-dried and/or pre-mixed raw materials 30. As another example, the cross-linking assembly 28 can be in a secondary operation altogether. That is, it is possible to wind up a run of thermoplastic non-halogenated flame retardant material and subsequently unwind and cross-link the material in a separate operation. As another example, the orienting and annealing assembly 72 is optional. As another example, the cutting assembly 70 is optional and the sheets 84 of cross-linked non-halogenated flame retardant polyolefin material can be simply wound onto a large core for use in a secondary process, e.g., incorporation into other products as a fabric or sheet, later cut into feeds, etc. In one arrangement, the sheet 84 is immediately used in the secondary process (e.g., fabric in car seats). In one arrangement, the feeds 86 are immediately used in a secondary process (e.g., contiguously provided for use in a cable manufacturing system).

Furthermore, it should be understood that the configuration of components of the cable manufacturing systems 130 was provided by way of example only. Other configurations are suitable for use as well. For example, it should understood that particular components such as the creasing assembly 142 and the positioning assembly 144 are unnecessary when manufacturing a cable 140 which uses a run of cross-linked non-halogenated flame retardant polyolefin material exclusively as a cable wrap. Similarly, the wrapping assembly 146 can be omitted when manufacturing a cable 140 which uses one or more runs of cross-linked non-halogenated flame retardant polyolefin material exclusively as separator tape.

Additionally, it should be understood that above-described embodiments of the invention are suitable for making runs of cross-linked non-halogenated flame retardant polyolefin material with a variety of thicknesses. In one arrangement, the run is substantially 0.050 inches thick. Such a run is well-suited for use as an electrical cable wrap (i.e., insulation around a set of conductors). In another arrangement, the run is substantially 0.010 inches thick. Such a run is well-suited for use as a separator for signal isolation. Other thickness are suitable for use as well. Such modifications and enhancements are intended to be within the scope of the invention.

What is claimed is:

1. A method for making a run of cross-linked non-halogenated flame retardant polyolefin material, the method comprising the steps of:
extruding molten non-halogenated flame retardant polyolefin material through a die that defines an elongated opening which is at least 7.5 centimeters wide;
cooling the extruded non-halogenated flame retardant polyolefin material so that the extruded non-halogenated flame retardant polyolefin material hardens into a sheet of non-halogenated flame retardant polyolefin material; and
cross-linking the sheet of non-halogenated flame retardant polyolefin material.

2. The method of claim 1 wherein the step of cross-linking includes the step of:
applying an electron-beam to the sheet of non-halogenated flame retardant polyolefin material.

3. The method of claim 1 wherein the step of cooling includes the step of:
forming, as the sheet of non-halogenated flame retardant polyolefin material, a web having a width which is at least 40 centimeters wide.

4. The method of claim 3, further comprising the step of:
winding the web onto a core which is at least 40 centimeters wide.

5. The method of claim 1, further comprising the step of:
dividing the sheet of non-halogenated flame retardant polyolefin material lengthwise to form multiple feeds of non-halogenated flame retardant polyolefin material.

6. The method of claim 5 wherein the step of dividing includes the step of:
cutting the sheet of non-halogenated flame retardant polyolefin material lengthwise prior to the step of cross-linking such that the step of cross-linking the sheet of non-halogenated flame retardant polyolefin material involves cross-linking the multiple feeds of non-halogenated flame retardant polyolefin material.

7. The method of claim 5 wherein the step of dividing includes the step of:
cutting the sheet of non-halogenated flame retardant polyolefin material lengthwise after the step of cross-linking.

8. The method of claim 5, further comprising the step of:
concurrently winding the multiple feeds of non-halogenated flame retardant polyolefin material onto multiple cores.

9. A system for making a run of cross-linked non-halogenated flame retardant polyolefin material, the system comprising:
an extruder having a die that defines an elongated opening which is at least 7.5 centimeters wide, the extruder being configured to extrude molten non-halogenated flame retardant polyolefin material through the die;
a cooling assembly coupled to the extruder, the cooling assembly being configured to cool the extruded non-halogenated flame retardant polyolefin material so that the extruded non-halogenated flame retardant polyolefin material hardens into a sheet of non-halogenated flame retardant polyolefin material; and
a cross-linking assembly coupled to the cooling assembly, the cross-linking assembly being configured to cross-link the sheet of non-halogenated flame retardant polyolefin material.

10. The system of claim 9 wherein the cross-linking assembly includes an electron beam device which is configured to apply an electron-beam to the sheet of non-halogenated flame retardant polyolefin material.

11. The system of claim 9 wherein the cooling assembly includes a cooling device which is configured to form, as the sheet of non-halogenated flame retardant polyolefin material, a web having a width which is at least 40 centimeters wide.

12. The system of claim 11, further comprising:
a winding assembly coupled to the cross-linking assembly, the winding assembly being configured to wind the web onto a core which is at least 40 centimeters wide.

13. The system of claim 9, further comprising:
a dividing assembly coupled to the cross-linking assembly, the dividing assembly being configured to divide the sheet of non-halogenated flame retardant polyolefin material lengthwise to form multiple feeds of non-halogenated flame retardant polyolefin material.

14. The system of claim 13 wherein the dividing assembly is disposed between the cooling assembly and the cross-linking assembly, and wherein the dividing assembly includes:
a set of cutters which is configured to cut the sheet of non-halogenated flame retardant polyolefin material lengthwise prior to cross-linking the sheet of non-halogenated flame retardant polyolefin material such that cross-linking the sheet of non-halogenated flame retardant polyolefin material involves cross-linking the multiple feeds of non-halogenated flame retardant polyolefin material.

15. The system of claim 13 wherein the dividing assembly includes:
a cutter which is configured to cut the sheet of non-halogenated flame retardant polyolefin material lengthwise after the sheet of non-halogenated flame retardant polyolefin material is cross-linked.

16. The system of claim 13, further comprising:
a winding assembly which is configured to concurrently wind the multiple feeds of non-halogenated flame retardant polyolefin material onto multiple cores.

17. A run of cross-linked non-halogenated flame retardant polyolefin material made by a method comprising the steps of:
extruding molten non-halogenated flame retardant polyolefin material through a die that defines an elongated opening which is at least 7.5 centimeters wide;
cooling the extruded non-halogenated flame retardant polyolefin material so that the extruded non-halogenated flame retardant polyolefin material hardens into a sheet of non-halogenated flame retardant polyolefin material; and
cross-linking the sheet of non-halogenated flame retardant polyolefin material.

18. The run of cross-linked non-halogenated flame retardant polyolefin material of claim 17 wherein the step of cross-linking includes the step of:
applying an electron-beam to the sheet of non-halogenated flame retardant polyolefin material.

19. The run of cross-linked non-halogenated flame retardant polyolefin material of claim 17 wherein the step of cooling includes the step of:
forming, as the sheet of non-halogenated flame retardant polyolefin material, a web having a width which is at least 40 centimeters wide.

20. The run of cross-linked non-halogenated flame retardant polyolefin material of claim 19 wherein the method further comprises the step of:
winding the web onto a core which is at least 40 centimeters wide.

21. The run of cross-linked non-halogenated flame retardant polyolefin material of claim 19 wherein the method further comprises the steps of:
cutting the web into multiple feeds; and
concurrently winding the multiple feeds onto multiple cores such that one of the concurrently wound multiple feed forms the run of cross-linked non-halogenated flame retardant polyolefin material.

22. A method for making a cable, the method comprising the steps of:
providing a set of conductors;
providing at least one run of cross-linked non-halogenated flame retardant polyolefin material; and
extruding a jacket around (i) the set of conductors and (ii) each run of cross-linked non-halogenated flame retardant polyolefin material to form the cable.

23. The method of claim 22, further comprising the step of:
positioning a run of cross-linked non-halogenated flame retardant polyolefin material between conductors of the set of conductors prior to the step of extruding.

24. The method of claim 22, further comprising the steps of:
creasing each run of cross-linked non-halogenated flame retardant polyolefin material; and
positioning each run of cross-linked non-halogenated flame retardant polyolefin material between conductors of the set of conductors prior to the step of extruding.

25. The method of claim 22, further comprising the step of:
wrapping a run of cross-linked non-halogenated flame retardant polyolefin material around the set of conductors prior to the step of extruding.

26. A system for making a cable, comprising:
a conductor source which is configured to provide a set of conductors;
a cross-linked non-halogenated flame retardant polyolefin material source which is configured to provide at least one run of cross-linked non-halogenated flame retardant polyolefin material; and
an extruding assembly coupled to conductor source and the cross-linked non-halogenated flame retardant polyolefin material source, the extruding assembly being configured to extrude a jacket around the set of conductors and each run of cross-linked non-halogenated flame retardant polyolefin material to form the cable.

27. The system of claim 26, further comprising:
a positioning assembly coupled to the cross-linking assembly, the positioning assembly being configured to position a run of cross-linked non-halogenated flame retardant polyolefin material between conductors of the set of conductors prior to extruding the jacket.

28. The system of claim 26, further comprising:
a creasing assembly coupled to the cross-linked non-halogenated flame retardant polyolefin material source, the creasing assembly being configured to crease each run of cross-linked non-halogenated flame retardant polyolefin material; and
a positioning assembly coupled to the creasing assembly and the conductor source, the positioning assembly being configured to position each run of cross-linked non-halogenated flame retardant polyolefin material between conductors of the set of conductors prior to extruding the jacket.

29. The system of claim 26, further comprising:
a wrapping assembly coupled to conductor source and the cross-linked non-halogenated flame retardant polyolefin material source, the wrapping assembly being configured to wrap a run of cross-linked non-halogenated flame retardant polyolefin material around the set of conductors prior to extruding the jacket.

30. A cable, comprising:
a set of conductors;
at least one run of cross-linked non-halogenated flame retardant polyolefin material; and
a jacket extruded around the set of conductors and each run of cross-linked non-halogenated flame retardant polyolefin material.

31. The cable of claim 30 wherein a run of cross-linked non-halogenated flame retardant polyolefin material is positioned to separate conductors of the set of conductors.

32. The cable of claim 30 wherein each run of cross-linked non-halogenated flame retardant polyolefin material (i) includes a crease along a midline of that run and (ii) is positioned to separate conductors of the set of conductors.

33. The cable of claim 30 wherein a run of cross-linked non-halogenated flame retardant polyolefin material wraps around the set of conductors.
